(19) United States
(12) Patent Application Publication
(10) Pub. No.: US 2024/0336498 A1
(43) Pub. Date: Oct. 10, 2024

(54) FLOATATION APPARATUS AND METHOD OF TREATING LIQUID MEDIUM

(71) Applicant: United States of America as Represented by The Secretary of the Army, Alexandria, VA (US)

(72) Inventors: Taylor E Rycroft, Concord, MA (US); Griffin Donohue, Vicksburg, MS (US)

(21) Appl. No.: 18/130,884

(22) Filed: Apr. 4, 2023

(51) Int. Cl. C02F 1/32; C02F 1/00

(52) U.S. Cl. CPC C02F 1/325; C02F 1/004; C02F 2103/007; C02F 2201/001; C02F 2201/3228; C02F 2303/04

(57) ABSTRACT

In one embodiment, a flotation apparatus for treating a liquid medium includes a flotation body; one or more UV lamps connected to the flotation body to be submerged in the liquid medium from the flotation body; and a filter screen connected to the flotation body to be submerged in the liquid medium upstream of the one or more UV lamps. The filter screen extends downward below a surface of the liquid medium to a lowest level which is disposed at or below a lowest level of the one or more UV lamps.

### STATEMENT OF GOVERNMENT INTEREST

Under paragraph 1 (a) of Executive Order 10096, the conditions under which this invention was made entitle the Government of the United States, as represented by the Secretary of the Army, to an undivided interest therein on any patent granted thereon by the United States. This and related patents are available for licensing to qualified licensees.

### BACKGROUND

### Field of the Invention

The present invention relates to apparatus and methods of treating a liquid medium and, more specifically, to flotation apparatus and methods of treating biological contamination including, for example, cyanobacteria, algae, or bacteria in a body of water.

### Description of the Related Art

This section introduces aspects that may help facilitate a better understanding of the invention. Accordingly, the statements of this section are to be read in this light and are not to be understood as admissions about what is prior art or what is not prior art.

It is known to use UV (ultraviolet) light, sonication, and/or ozone to treat harmful algal bacteriablooms and detoxify liquid and solid materials having toxic organic compounds. For instance, U.S. Pat. No. 8,097,170 discloses a device for treating a liquid medium which utilizes an ultrasound emitter located relative to a compartment of a container holding a liquid medium and microbubble emitter located relative to the compartment. U.S. Patent Application Publication No. 2021/0032128 discloses apparatus and method of applying at least one of UVC irradiation, microbubbles, and ultrasonic sound to mitigate harmful water-borne bacteria. U.S. Patent Application Publication No. 2021/0347662 discloses a floating vessel such as a pontoon boat containing electrolysis cells for controlling or destroying red tide. U.S. Patent Application Publication No. 2021/0238065 discloses an electrochemical reactor and electrode materials installed on boats and docks to directly treat harmful algae contaminated water. Yasushi Iseri et al., “Development of a boat equipped with UV lamps for suppression of freshwater red tide in reservoir,” Japanese Journal of Water Treatment Biology, Vol. 29, No. 2, 61-70 (1993) discloses a boat equipped with UV lamps to suppress freshwater red tide.

### SUMMARY

The present invention was developed to address the desire for a more robust and effective way to treat harmful algal blooms and detoxify liquid and solid materials having toxic organic compounds in a body of water. Research and development have led to novel flotation apparatus and methods that enable the use of a UV reactor on a floating body such as a pontoon boat. A filter screen upstream of the UV reactor protects the UV reactor. A propeller disposed between the filter screen and the UV reactor causes mixing of the liquid medium upstream of the UV reactor before it is exposed to the UV-C radiation, thereby improving the efficiency of treating the liquid medium. Lining the UV reactor with a UV-reflecting material to reflect UV radiation from the UV-C emitter toward the liquid medium improves the efficiency and effectiveness of the UV reactor in treating the liquid medium.

According to an aspect the present invention, a flotation apparatus for treating a liquid medium includes a flotation body; one or more UV lamps connected to the flotation body to be submerged in the liquid medium from the flotation body; and a filter screen connected to the flotation body to be submerged in the liquid medium upstream of the one or more UV lamps. The filter screen extends downward below a surface of the liquid medium to a lowest level which is disposed at or below a lowest level of the one or more UV lamps.

In some embodiments, the filter screen has a cow-catcher shape with a leading apex disposed at a most upstream location of the filter screen and is wider than the one or more UV lamps. The filter screen has a plurality of openings to allow the liquid medium to pass therethrough, the openings being no larger than about 0.5 inches in lateral dimension across each of the openings. A propeller is disposed between the filter screen and the influent zone of the one or more UV lamps.

In specific embodiments, the one or more UV lamps are disposed in a UV reactor. The UV reactor has a UV-reflecting material lining its walls to reflect UV radiation from the one or more UV lamps toward the liquid medium. The UV reactor may be lined with the UV-reflecting material. The UV-reflecting material may include PTFE, e-PTFE, sputtered aluminum, or aluminum foil. The UV reactor has a fixed reactor width and is no wider than the filter screen.

In accordance with another aspect of the invention, a flotation apparatus for treating a liquid medium comprises: a flotation body; a UV-C emitter connected to the flotation body to be submerged in the liquid medium from the flotation body; a filter screen connected to the flotation body to be submerged partially in the liquid medium upstream of the UV-C emitter; and a propeller disposed between the filter screen and the UV-C emitter.

In some embodiments, the UV-C emitter is disposed in a UV reactor. The UV reactor having a UV-reflecting material to reflect UV radiation from the UV-C emitter toward the liquid medium.

In accordance with another aspect, a flotation apparatus for treating a liquid medium comprises: a flotation body; a UV-C emitter connected to the flotation body to emit UV-C radiation toward the liquid medium from the flotation body; and a filter screen connected to the flotation body to be submerged in the liquid medium upstream of the UV-C emitter, the filter screen extending downward below a surface of the liquid medium to a lowest level which is about seven inches below the surface of the liquid medium.

In some embodiments, the filter screen has a convex shape with a leading edge disposed at a most upstream location of the filter screen and is wider than the UV-C emitter. The filter screen has a plurality of openings to allow the liquid medium to pass therethrough, the openings being no larger than about 0.5 inches in lateral dimension across each of the openings.

In accordance with yet another aspect, a method of treating a liquid medium comprises: floating a flotation body on the liquid medium; submerging one or more UV lamps (radiation emitter) in the liquid medium from the flotation body; and placing a filter screen in the liquid medium upstream of the one or more UV lamps, the filter screen extending downward from a surface of the liquid medium to a lowest level which is disposed at or below a lowest level of the one or more UV lamps.

In some embodiments, placing the filter screen comprises connecting, to the flotation body at a location upstream of the one or more UV lamps, a cow-catcher shaped filter screen with a leading apex disposed at a most upstream location of the filter screen. The method may include screening the liquid medium upstream of the one or more UV lamps using the filter screen which has a plurality of openings to allow the liquid medium to pass therethrough, the openings being no larger than about 0.5 inches in lateral dimension across each of the openings.

In specific embodiments, the method further includes disposing a propeller between the filter screen and the one or more UV lamps to propel the flotation body over the surface of the liquid medium and to cause mixing of the liquid medium upstream of the one or more UV lamps and downstream of the filter screen. The method may include reflecting UV radiation from the one or more UV lamps toward the liquid medium. Reflecting the UV radiation may include lining a UV reactor in which the one or more UV lamps are disposed with the UV-reflecting material. Lining the UV reactor may include PTFE, e-PTFE, or sputtered aluminum on a surface of the UV reactor or covering a surface of the UV reactor with aluminum foil.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 illustrates a perspective view of a flotation apparatus for treating a liquid medium according to an embodiment of the present invention.

FIG. 2 illustrates another perspective view of the flotation apparatus of FIG. 1.

FIG. 3 illustrates a perspective view of a UV reactor attached to the flotation apparatus of FIG. 1.

FIG. 4 illustrates a front elevational view of the flotation apparatus of FIG. 1.

FIG. 5 illustrates a rear elevational view of the flotation apparatus of FIG. 1.

FIG. 6 illustrates a left side elevational view of the flotation apparatus of FIG. 1.

FIG. 7 illustrates a top plan view of the flotation apparatus of FIG. 1.

FIG. 8 illustrates a bottom plan view of the flotation apparatus of FIG. 1.

FIG. 8A illustrates an example of a propeller.

FIG. 9 illustrates a front elevational view of a cow-catcher filter screen according to an embodiment.

FIG. 10 illustrates a top plan view of the cow-catcher filter screen of FIG. 9.

FIG. 11 illustrates a side elevational view of the cow-catcher filter screen of FIG. 9.

FIG. 12 illustrates a perspective view of a convex filter screen according to another embodiment.

FIG. 13 illustrates a side view of the convex filter screen of FIG. 12.

FIG. 14 illustrates a front view of the convex filter screen of FIG. 12.

FIG. 15 illustrates a top view of the convex filter screen of FIG. 12.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Embodiments of the present invention provide a novel flotation apparatus and methods that uses a UV reactor on a floating body to expose flowing water to light from UV lamps. A filter screen upstream of the UV reactor protects the UV reactor from damage from floating debris or the like. A propeller disposed between the filter screen and the UV reactor propels the flotation apparatus and causes mixing of the liquid medium upstream of the UV reactor before it is exposed to the UV-C radiation, thereby improving the efficiency of treating the liquid medium. Lining the walls of the UV reactor with a UV-reflecting material to reflect UV radiation from the UV-C emitter toward the liquid medium improves the efficiency and effectiveness of the UV reactor in treating the liquid medium flowing past the propeller toward the UV reactor.

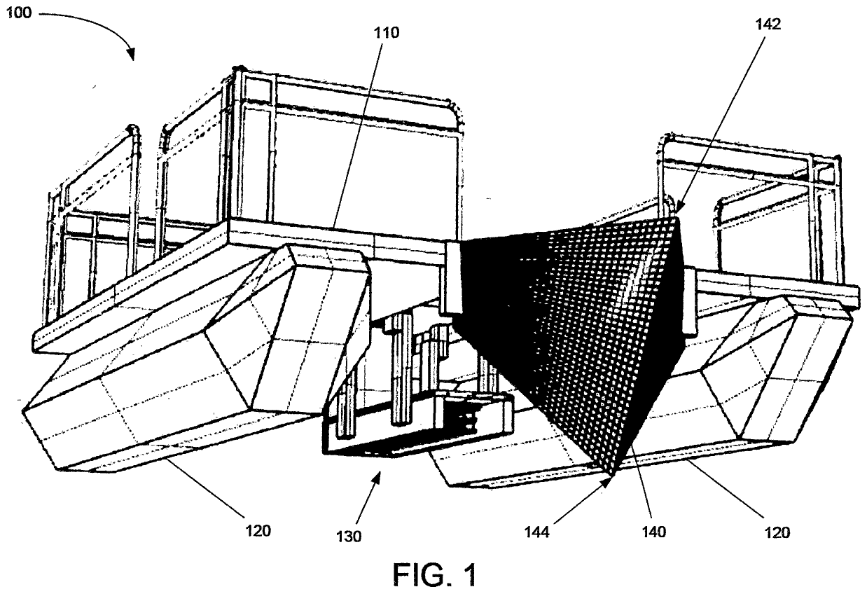

FIG. 1 illustrates a perspective view of a flotation apparatus for treating a liquid medium according to an embodiment of the present invention. The flotation apparatus 100 includes a flotation body 110 having a pair of flotation members 120. A UV reactor 130 is attached to the flotation body 110 to be submerged in the liquid medium from the flotation body 110. A filter screen 140 connected to the flotation body to be submerged in the liquid medium upstream of the UV reactor 130. In the embodiment shown, the filter screen 140 has a cow-catcher shape with a leading apex 142 disposed at a most upstream location of the filter screen 140. It has a filter screen bottom 144 at a lowest level of the filter screen 140.

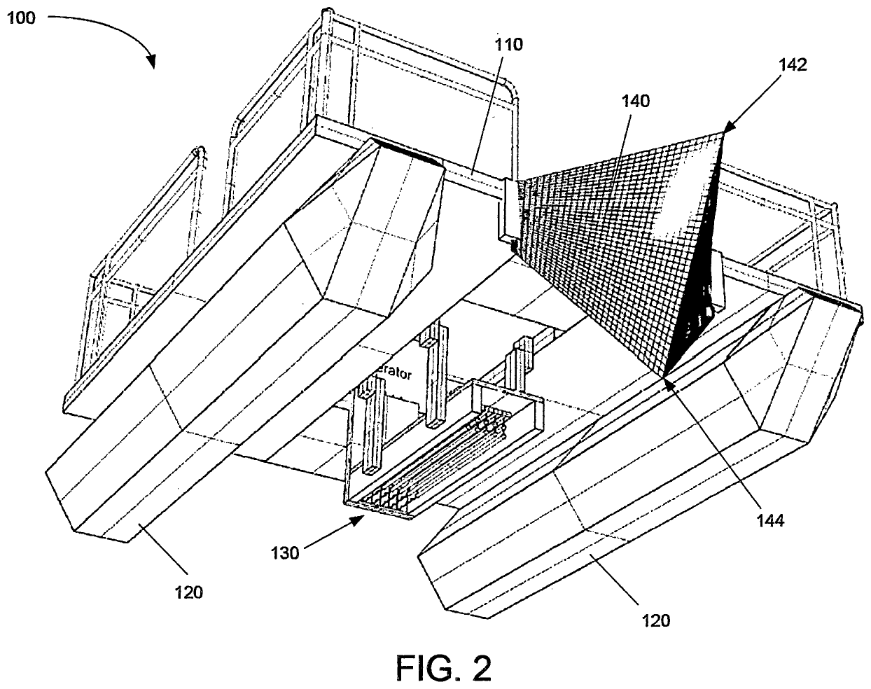

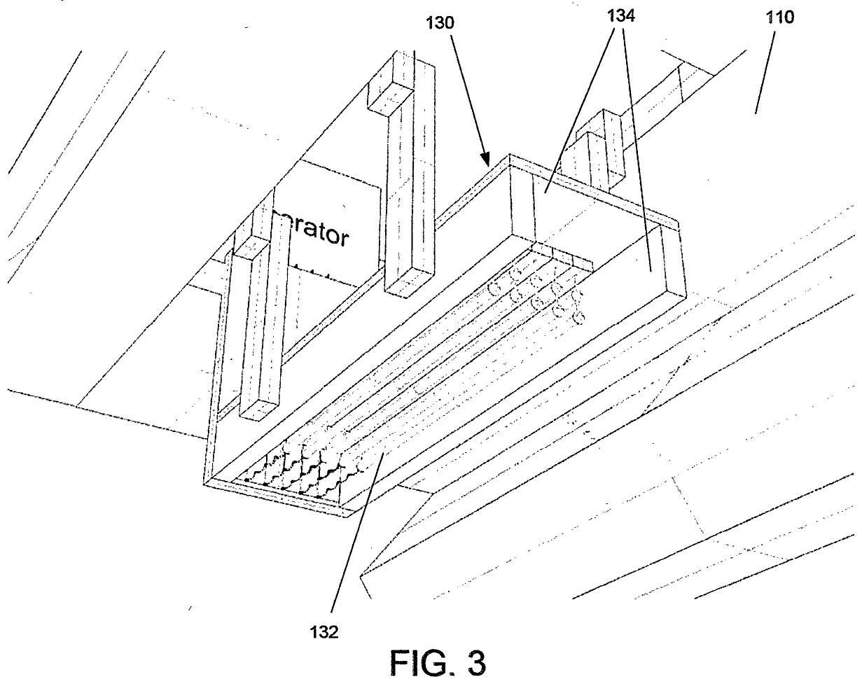

FIG. 2 illustrates another perspective view of the flotation apparatus of FIG. 1. FIG. 3 illustrates a perspective view of the UV reactor attached to the flotation apparatus of FIG. 1. The UV reactor 130 includes a UV-C emitter which may include one or more UV lamps 132. In the embodiment shown, there are ten UV lamps 132 arranged longitudinally along a length of the flotation body 110. The UV lamps 132 may be arranged into two rows (in a vertical direction along a depth of the flotation body 110) of five UV lamps 132 (in a width direction along a width of the flotation body 110) in each row. The UV lamps 132 may be disposed in pipes in the longitudinal direction along the influent flow of the liquid medium. The UV lamps 132 are connected to the flotation body 110 to be submerged in the liquid medium from the flotation body 110. In one example, the UV lamps 132 are 87.5-watt lamps arranged in a single bank, 5 modules, 2 lamps per module, in stainless steel channel.

The inside walls of the UV reactor 130 may include a UV-reflecting material 134 to reflect UV radiation from the UV-C emitter toward the liquid medium. The UV reactor may be lined with the UV-reflecting material 134. The UV-reflecting material may include PTFE, e-PTFE, sputtered aluminum, or aluminum foil on surfaces of the UV reactor adjacent or in proximity of the UV lamps 132. The UV-reflecting material has a high reflectance (e.g., at least about 95%). The UV-reflecting material may be less than about 1 mm in thickness (e.g., about 0.75 mm thick). Lining the UV reactor 130 with a UV-reflecting material to reflect UV radiation from the UV-C emitter toward the liquid medium improves the efficiency and effectiveness of the UV reactor 130 in treating the liquid medium flowing toward the UV reactor 130. For instance, the use of PTFE as UV-reflecting material over the stainless-steel walls can result in approximately a 3-fold improvement in reflectivity compared to the UV reflectivity of the stainless-steel walls.

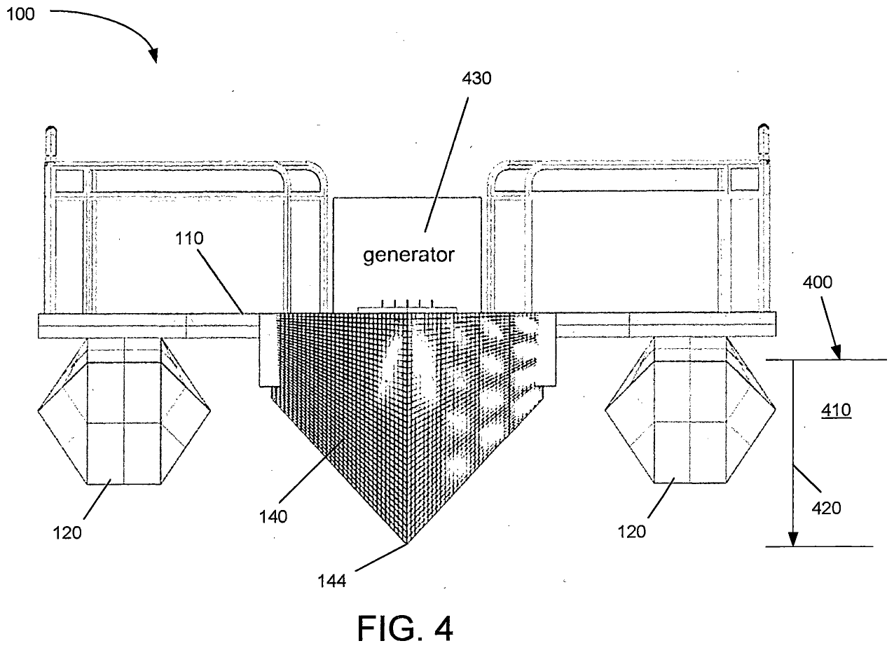

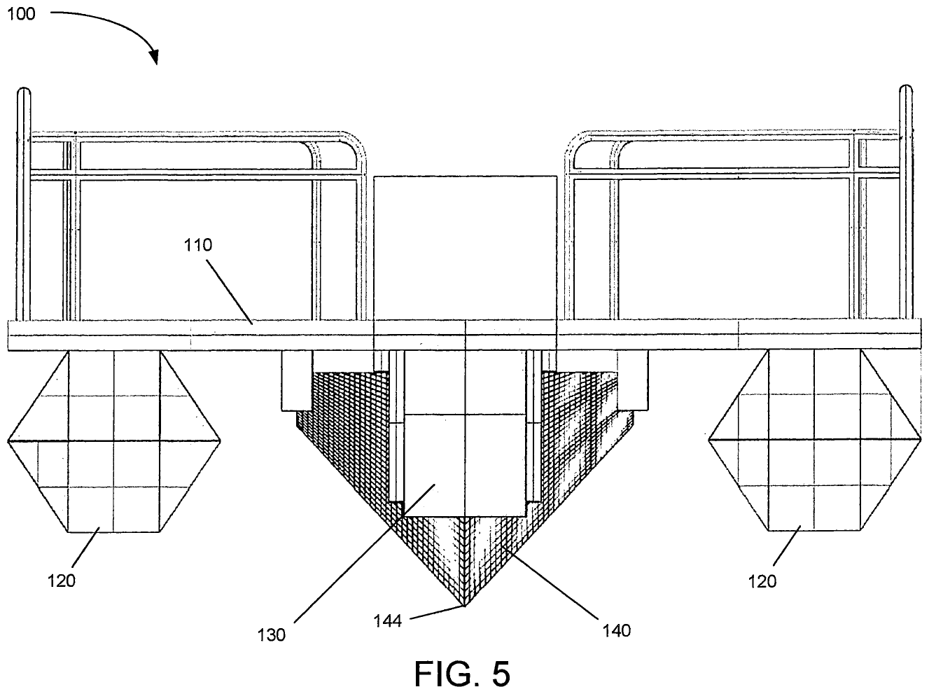

FIG. 4 illustrates a front elevational view of the flotation apparatus of FIG. 1. FIG. 5 illustrates a rear elevational view of the flotation apparatus of FIG. 1. They show the arrangement and dimensions of the UV reactor 130 and the filter screen 140 in the width direction along the width of the flotation body 110 and in the depth direction along the depth of the flotation body 110. The UV reactor 130 has a fixed reactor width and is no wider than the filter screen 140. The water level in the UV reactor 130 may be approximately 7 inches deep (which may be weir controlled) so as to focus the germicidal light on the first 7 inches of the water column where the target organisms (e.g., cyanobacteria) are anticipated to concentrate. The target treatment dose may be 20 mJ/cm² based on laboratory studies on the UV-C sensitivity of the cHAB species Microcystis aeruginosa which showed a 3-day suppression of growth after 20 mJ/cm² irradiation. The dose administered is dependent on customer requirements. The dose can be adjusted by adjusting the speed of the boat. In one example, the flotation apparatus 100 is driven at a rate of 0.94 ft/s (0.64 mph) to suppress 1 acre of a bloom at 7-in depth in 10.2 hours, assuming a 60% UV transmittance within the bloom. The flotation apparatus 100 may be steered by an electric trolling motor (e.g., 55-lb thrust, 54″ shaft bow mount).

The filter screen 140 extends downward below a surface 400 of the liquid medium 410 to a lowest level at a filter screen bottom 144 which is disposed at or below a lowest level of the UV reactor 130. In an example, the filter screen 140 extends downward below a surface of the liquid medium to a lowest level which is a depth 420 of about seven inches below the surface 400 of the liquid medium 410 (e.g., 7 inches ±1.4 inches or ±0.7 inches or ±0.35 inches).

A generator 430 provides electrical power to the UV reactor 130 (including the UV lamps 132 and system monitor) and the trolling motor. An example is a 5000 W portable generator manufactured by Dayton. The propeller 150 may be part of the 55 lbs. thrust, 54″ shaft, bow-mounted MinnKota foot-controlled trolling motor.

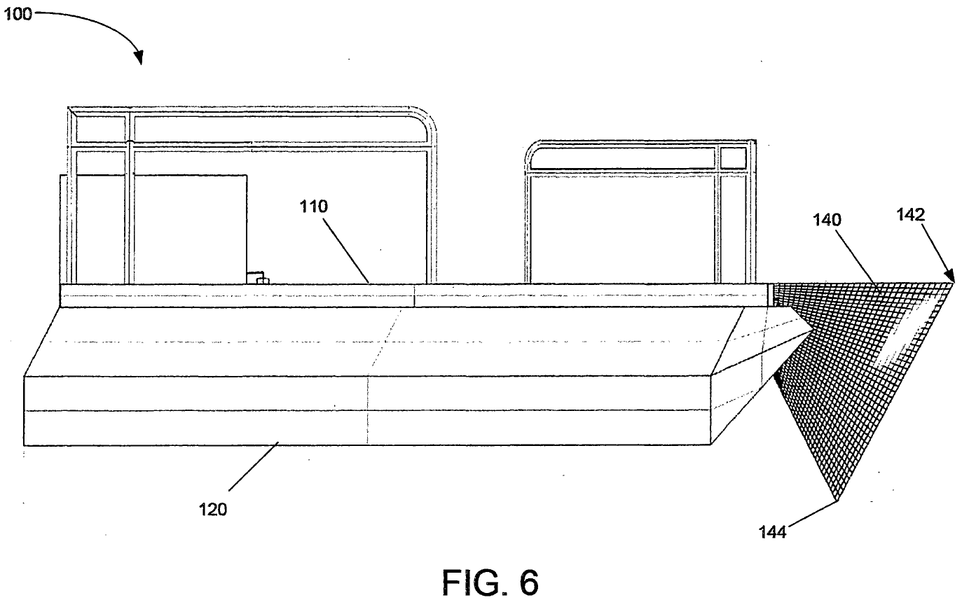

FIG. 6 illustrates a left side elevational view of the flotation apparatus of FIG. 1. It shows the arrangement and dimensions of the filter screen 140 in the length direction along the length of the flotation body 110 and in the depth direction along the depth of the flotation body 110. The filter screen bottom 144 at the lowest level of the filter screen 140 is disposed below the lowest level of the UV reactor 130. In the example shown, the filter screen bottom 144 at the lowest level of the filter screen 140 is disposed below the bottom of the flotation body 110 which is at or below the lowest level of the UV reactor 130.

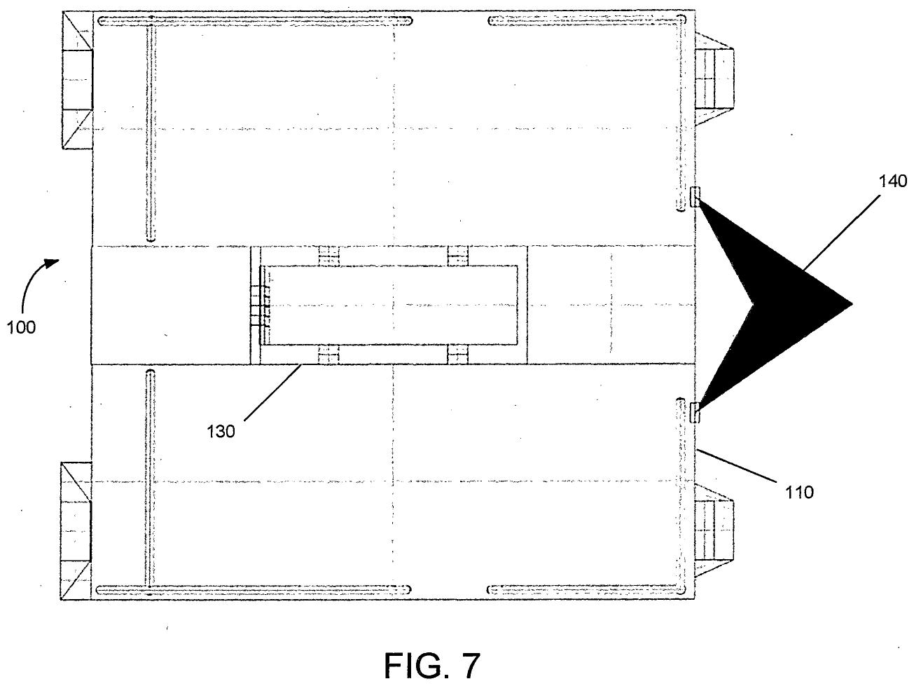

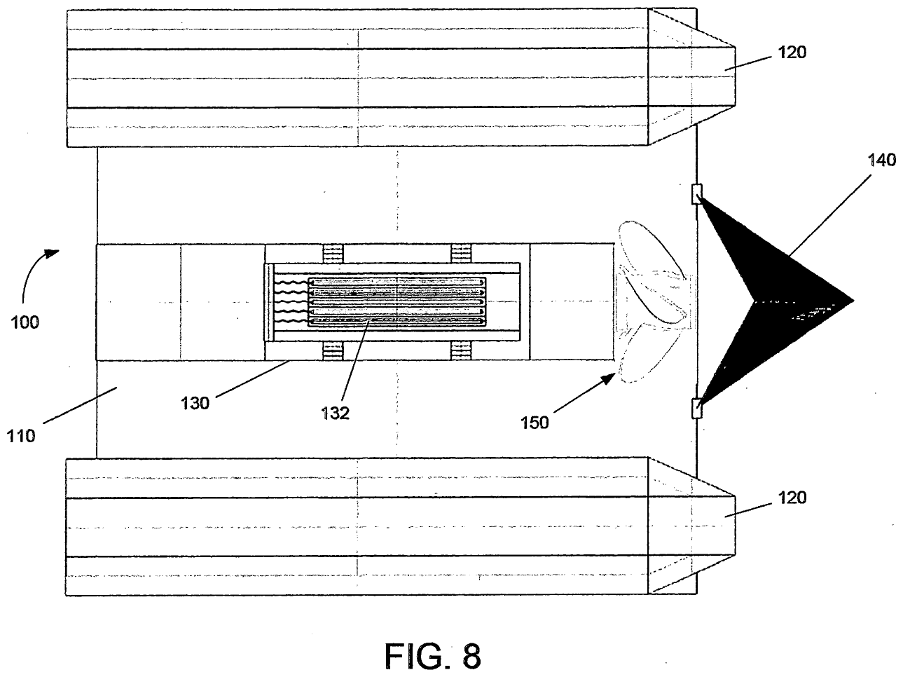

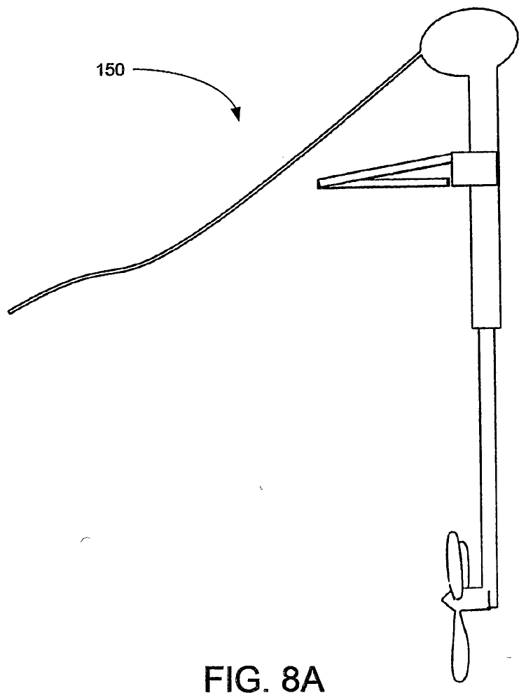

FIG. 7 illustrates a top plan view of the flotation apparatus of FIG. 1. FIG. 8 illustrates a bottom plan view of the flotation apparatus of FIG. 1. They show the arrangement and dimensions of the UV reactor 130 and the filter screen 140 in the length direction along the length of the flotation body 110 and in the width direction along the width of the flotation body 110. The UV reactor 130 is no wider than the filter screen 140. More specifically, at a minimum, the filter screen 140 is at least as wide as the arrangement of UV lamps 132.

FIG. 8A illustrates an example of a propeller. The propeller 150 is disposed between an influent zone of the UV reactor 130 and the filter screen 140. The propeller 150 propels the flotation body 110 over the surface of the liquid medium 410 to control the velocity of the liquid medium through the UV reactor 130. The propeller 150 also causes mixing of the liquid medium 410 upstream of the UV reactor 130 and downstream of the filter screen 140 (e.g., in the influent zone of the UV reactor 130). The mixing of the liquid medium 410 before it is exposed to the UV-C radiation can improve the efficiency of treating the liquid medium such as harmful algal blooms and detoxifying liquid and solid materials having toxic organic compounds.

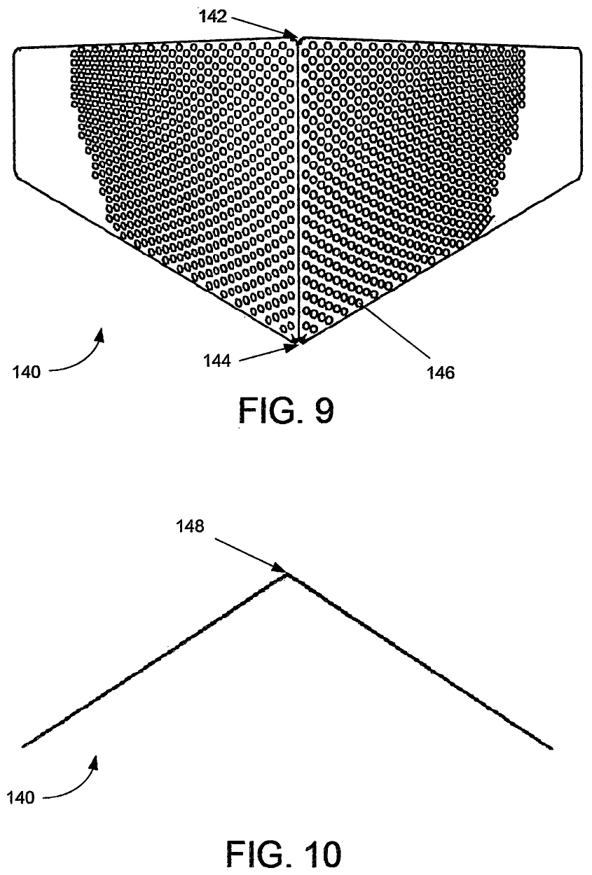

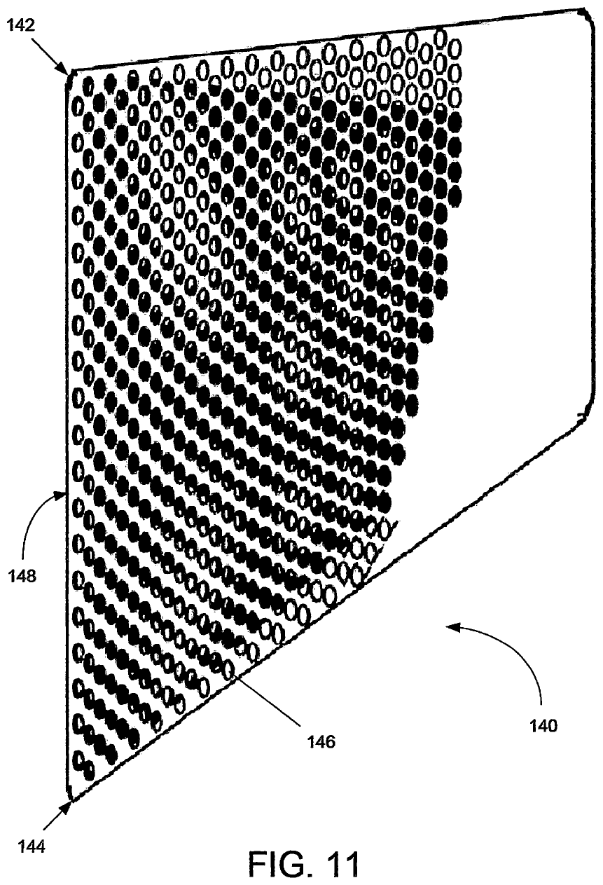

FIG. 9 illustrates a front elevational view of a cow-catcher filter screen according to an embodiment. FIG. 10 illustrates a top plan view of the cow-catcher filter screen of FIG. 9. FIG. 11 illustrates a side elevational view of the cow-catcher filter screen of FIG. 9.

In the embodiment shown, the cow-catcher filter screen 140 has the leading apex 142 disposed at the most upstream location of the filter screen 140 and a filter screen bottom 144 at the lowest level of the filter screen 140. It has an inclined leading edge 148 extending between the leading apex 142 and the filter screen bottom 144. The filter screen 140 has a plurality of openings 146 to allow the liquid medium to pass therethrough. The openings 146 may be no larger than about 0.5 inches in lateral dimension across each of the openings 146 (e.g., 0.5 inches ±0.1 inches or ±0.05 inches or ±0.025 inches). The filter screen 140 screens the influent flow of liquid medium to the UV reactor 130 to prevent relatively large floating/suspended bodies (e.g., weeds, sticks, aquatic animals, etc.) from hitting or coming in contact with the UV reactor 130 and the UV lamps 132. The filter screen 140 may be made of metal, polymer, or composites such as fiberglass. In one example, the filter screen 140 is made from cutting and shaping an aluminum perforated sheet. The filter screen 140 may be about 0.125-in thick with approximately 0.5-in holes at approximately 0.6875-in stagger. The filter screen 140 may be made from aluminum perforated sheet conformed in the cow-catcher shape.

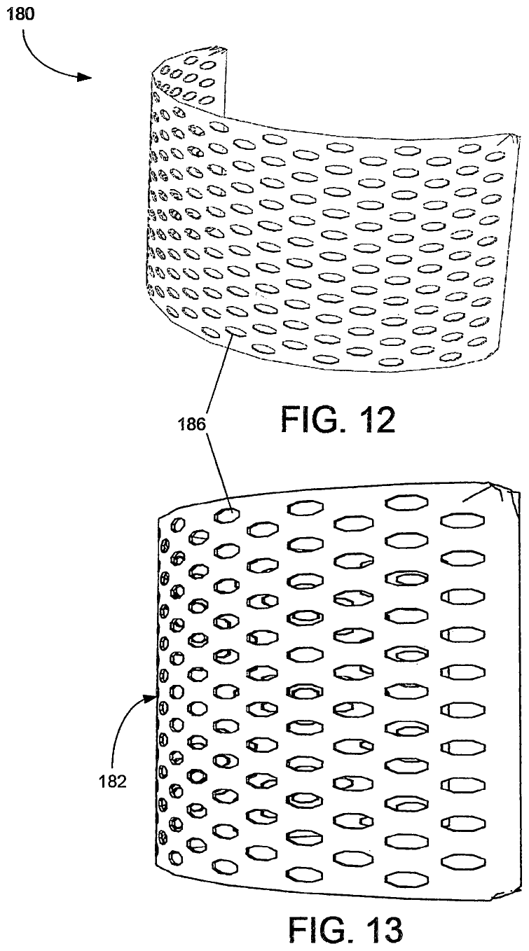

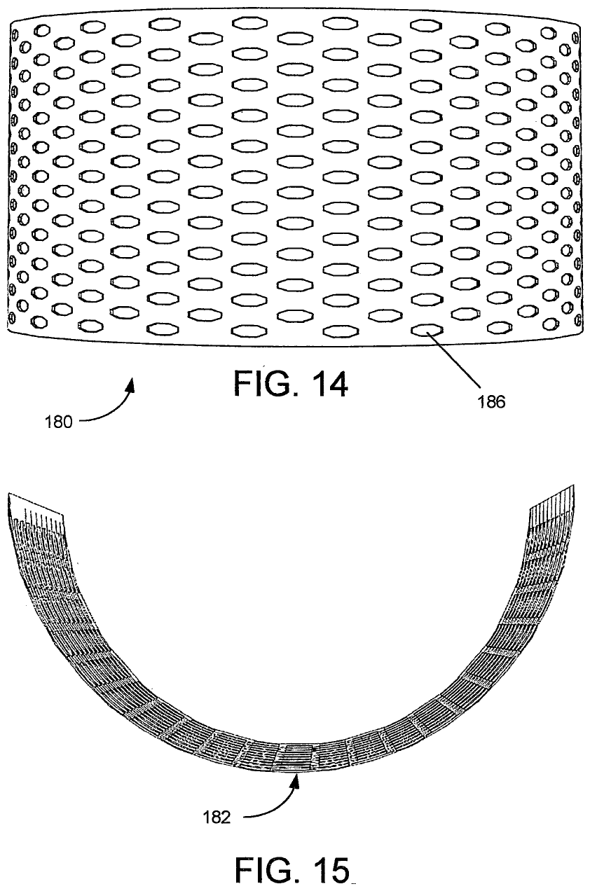

FIG. 12 illustrates a perspective view of a convex filter screen according to another embodiment. FIG. 13 illustrates a side view of the convex filter screen of FIG. 12. FIG. 14 illustrates a front view of the convex filter screen of FIG. 12. FIG. 15 illustrates a top view of the convex filter screen of FIG. 12.

In the embodiment shown, the convex filter screen 180 has the vertical leading edge 182 disposed at the most upstream location of the filter screen 180. The filter screen 180 has a plurality of openings 186 to allow the liquid medium to pass therethrough. The openings 186 may be no larger than about 0.5 inches in lateral dimension across each of the openings 186. The filter screen 180 may be made of metal, polymer, or composites. In one example, the filter screen 180 is made from cutting and shaping an aluminum perforated sheet. The convex filter screen 180 of this example has a U-shape or an arc shape. In another example, the convex filter screen may have a V-shape or some other convex shapes with a vertical leading edge similar to the leading edge 182 in FIGS. 12-15 or an inclined leading edge similar to the leading edge 148 in FIGS. 9-11.

Embodiments of the invention can be manifest in the form of methods and apparatuses for practicing those methods.

Unless explicitly stated otherwise, each numerical value and range should be interpreted as being approximate as if the word “about” or “approximately” preceded the value or range.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

All documents mentioned herein are hereby incorporated by reference in their entirety or alternatively to provide the disclosure for which they were specifically relied upon.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A flotation apparatus for treating a liquid medium, the flotation apparatus comprising:
a flotation body;
one or more UV lamps connected to the flotation body to be submerged in the liquid medium from the flotation body; and
a filter screen connected to the flotation body to be submerged in the liquid medium upstream of the one or more UV lamps, the filter screen extending downward below a surface of the liquid medium to a lowest level which is disposed at or below a lowest level of the one or more UV lamps.

2. The flotation apparatus of claim 1,
wherein the filter screen has a cow-catcher shape with a leading apex disposed at a most upstream location of the filter screen and is wider than the one or more UV lamps.

3. The flotation apparatus of claim 1,
wherein the filter screen has a plurality of openings to allow the liquid medium to pass therethrough, the openings being no larger than about 0.5 inches in lateral dimension across each of the openings.

4. The flotation apparatus of claim 1, further comprising:
a propeller disposed between the filter screen and the one or more UV lamps.

5. The flotation apparatus of claim 1, further comprising:
a UV reactor in which the one or more UV lamps are disposed, the UV reactor having a UV-reflecting material to reflect UV radiation from the one or more UV lamps toward the liquid medium.

6. The flotation apparatus of claim 5,
wherein the UV reactor is lined with the UV-reflecting material.

7. The flotation apparatus of claim 5,
wherein the UV-reflecting material comprises PTFE, e-PTFE, sputtered aluminum, or aluminum foil.

8. A flotation apparatus for treating a liquid medium, the flotation apparatus comprising:
a flotation body;
a UV-C emitter connected to the flotation body to be submerged in the liquid medium from the flotation body;
a filter screen connected to the flotation body to be submerged partially in the liquid medium upstream of the UV-C emitter; and
a propeller disposed between the filter screen and the UV-C emitter.

9. The flotation apparatus of claim 8,
wherein the filter screen has a cow-catcher shape with a leading apex disposed at a most upstream location of the filter screen and is wider than the UV-C emitter.

10. The flotation apparatus of claim 8,
wherein the filter screen has a plurality of openings to allow the liquid medium to pass therethrough, the openings being no larger than about 0.5 inches in lateral dimension across each of the openings.

11. The flotation apparatus of claim 8, further comprising:
a UV reactor in which the UV-C emitter is disposed, the UV reactor having a UV-reflecting material to reflect UV radiation from the UV-C emitter toward the liquid medium.

12. The flotation apparatus of claim 11,
wherein the UV reactor is lined with the UV-reflecting material.

13. A flotation apparatus for treating a liquid medium, the flotation apparatus comprising:
a flotation body;
a UV-C emitter connected to the flotation body to emit UV-C radiation toward the liquid medium from the flotation body; and
a filter screen connected to the flotation body to be submerged in the liquid medium upstream of the UV-C emitter, the filter screen extending downward below a surface of the liquid medium to a lowest level which is about seven inches below the surface of the liquid medium.

14. The flotation apparatus of claim 13,
wherein the filter screen has a cow-catcher shape with a leading apex disposed at a most upstream location of the filter screen and is wider than the UV-C emitter.

15. The flotation apparatus of claim 13,
wherein the filter screen has a convex shape with a leading edge disposed at a most upstream location of the filter screen and is wider than the UV-C emitter.

16. The flotation apparatus of claim 13,
wherein the filter screen has a plurality of openings to allow the liquid medium to pass therethrough, the openings being no larger than about 0.5 inches in lateral dimension across each of the openings.

17. The flotation apparatus of claim 13, further comprising:
a propeller disposed between the filter screen and the UV-C emitter.

18. The flotation apparatus of claim 13, further comprising:
a UV reactor in which the UV-C emitter is disposed, the UV reactor having a UV-reflecting material to reflect UV radiation from the UV-C emitter toward the liquid medium.

19. The flotation apparatus of claim 18,
wherein the UV reactor is lined with the UV-reflecting material.

20. The flotation apparatus of claim 18,
wherein the UV-reflecting material comprises PTFE, e-PTFE, sputtered aluminum, or aluminum foil.
